(19) United States
(12) Patent Application Publication
(10) Pub. No.: US 2025/0323384 A1
(43) Pub. Date: Oct. 16, 2025

(54) SECONDARY BATTERY

(71) Applicant: Samsung SDI Co., Ltd., Yongin-si (KR)

(72) Inventors: Myung Seob KIM, Yongin-si (KR); Mun Sung KIM, Yongin-si (KR); Hwan Jun OH, Yongin-si (KR); Jung Hyun PARK, Yongin-si (KR); Sung Gwi KO, Yongin-si (KR); Gwan Hyeon YU, Yongin-si (KR); Yoon Sun YOO, Yongin-si (KR); Woo Tae JUN, Yongin-si (KR); Gun Gue PARK, Yongin-si (KR)

(21) Appl. No.: 19/012,271

(22) Filed: Jan. 7, 2025

(30) Foreign Application Priority Data
Apr. 15, 2024 (KR) 10-2024-0049783

(51) Int. Cl. H01M 50/477; B60R 16/033; H01M 50/107; H01M 50/152; H01M 50/186; H01M 50/474; H01M 50/533; H01M 50/536; H01M 50/548; H01M 50/567; H01M 50/583

(52) U.S. Cl. CPC H01M 50/477; H01M 50/107; H01M 50/152; H01M 50/186; H01M 50/474; H01M 50/533; H01M 50/536; H01M 50/548; H01M 50/567; H01M 50/583; B60R 16/033; H01M 2200/103; H01M 2220/20

(57) ABSTRACT

A secondary battery includes an electrode assembly including a first electrode plate, a separator, and a second electrode plate; a case accommodating the electrode assembly; a terminal penetrating an upper side portion of the case and coupled to the case with a first gasket; a first current collector plate between an upper side portion of the electrode assembly and the case and electrically connecting the first electrode plate and the terminal; and a cap plate sealing an open lower end of the case. The first current collector plate includes an electrode plate connection part connected to the first electrode plate, and a terminal connection part coupled to a terminal hole of the case and including a fastening part coupled to the upper side of the terminal connection part. An insulating member is attached to the first current collector plate and avoids a current collection welding area.

### CROSS-REFERENCE TO RELATED APPLICATION

The present application claims priority to and the benefit of Korean Patent Application No. 10-2024-0049783, filed on Apr. 15, 2024, in the Korean Intellectual Property Office, the entire disclosure of which is incorporated herein by reference.

### BACKGROUND

### 1. Field

The present disclosure relates to a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage).

Such secondary batteries may be classified into cylindrical, prismatic, pouch, etc., depending on their appearance. Among them, a cylindrical secondary battery typically may be included an electrode assembly, a can, a cap assembly, etc. In addition, the secondary battery may benefit from one or more features to increase stability within a cell and to prevent internal short circuits.

The above information disclosed in this Background section is for enhancement of understanding of the background of the present disclosure, and therefore, it may contain information that does not constitute related (or prior) art.

### SUMMARY

The present disclosure relates to various embodiments of a secondary battery configured to increase stability within a cell and prevent (or at least mitigate) an internal short circuit.

These and other aspects and features of the present disclosure will be described in or will be apparent from the following description of embodiments of the present disclosure.

A secondary battery according to an embodiment of the present disclosure may include: an electrode assembly including a first electrode plate, a separator, and a second electrode plate; a case accommodating the electrode assembly and having an open lower end; a terminal penetrating an upper side portion of the case and coupled to the case with a first gasket; a first current collector plate between an upper side portion of the electrode assembly and the case and electrically connecting the first electrode plate and the terminal to each other; and a cap plate sealing the open lower end of the case. The first current collector plate includes an electrode plate connection part connected to the first electrode plate of the electrode assembly, and a terminal connection part at the center of the electrode plate connection part and connected to the terminal. The terminal is coupled to a terminal hole of the case and includes a fastening part located inside the case. The fastening part is coupled to an upper side portion of the terminal connection part. An insulating member is attached to the first current collector plate and avoids a current collection welding area between the first current collector plate and the first electrode plate.

The first current collector plate may further include a fuse part between the terminal connection part and the electrode plate connection part.

The fuse part may include a fuse hole extending along a portion of the outer circumference of the terminal connection part; and an electrode plate joint part that connects the terminal connection part and the electrode plate connection part.

The fuse hole may have a C-shape in a plan view.

The insulating member may be attached to the lower side of the fuse part.

A diameter of the insulating member may be equal to or larger than a diameter of the fuse part.

The diameter of the insulating member may be approximately 20% to approximately 40% of a diameter of the electrode assembly.

The insulating member may be circular.

The insulating member may be prismatic.

The insulating member may be an insulating tape, and an adhesive may be attached to both edges of the insulating tape facing each other.

The insulating member may be an insulating tape, and an adhesive may be attached to a portion of an edge of the insulating tape.

The insulating member may be an insulating tape, and an adhesive may be attached to the outside of the insulating tape along the edge of the insulating tape.

The adhesive may have a circular shape.

The fuse hole may have a circular shape in a plan view and extend along the outer circumference of the terminal connection part.

The current collection welding area may extend radially from an edge area of the first current collector plate.

The first current collector plate may be outside the fuse part and may include two or more buffering slits that are substantially symmetrical about the fuse part.

Each of the buffering slits may be U-shaped in a plan view.

The insulating member may be attached to the lower side of the fuse part and may avoid the current collection welding area and the buffering slits.

The fuse part may include one or more fuse holes, and the fuse holes may be located in a concentric circle with respect to the center of the first current collector plate.

The terminal connection part may protrude toward the electrode assembly and include a step with respect to the electrode plate connection part.

The insulating member may be an insulating tape or may be a coating of a material having an insulating property.

The case may be cylindrical.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to a first embodiment of the present disclosure.

FIG. 2 is a sectional view of the secondary battery according to the first embodiment of the present disclosure.

FIG. 3 is an enlarged view of portion A in FIG. 2.

FIG. 4 is a diagram showing a first current collector plate, an insulating member on the first current collector plate, and a welding area of the first current collector plate, according to an embodiment of the present disclosure.

FIG. 5 is a diagram showing a first current collector plate and an insulating member on the first current collector plate, according to another embodiment of the present disclosure.

FIG. 6 is a diagram showing the coating form of an adhesive coated on an insulating tape during the manufacturing process of a secondary battery according to an embodiment of the present disclosure.

FIG. 7 is a diagram showing the coating form of an adhesive coated on an insulating tape during the manufacturing process of a secondary battery according to another embodiment of the present disclosure.

FIG. 8 is a diagram showing the coating form of an adhesive coated on an insulating tape during the manufacturing process of a secondary battery according to another embodiment of the present disclosure.

FIG. 9 is a diagram showing the coating form of an adhesive coated on an insulating tape during the manufacturing process of a secondary battery according to another embodiment of the present disclosure.

FIGS. 10A and 10B are diagrams schematically showing the configuration of a secondary battery pack according to an embodiment of the present disclosure.

FIG. 11A is a perspective view showing a vehicle body according to one embodiment of the present disclosure.

FIG. 11B is a diagram of a vehicle including the secondary battery pack of FIG. 10 according to one embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being disposed (or located or positioned) on the “above (or below)” or “on (or under)” a component, it may mean that the arbitrary element is placed in contact with the upper (or lower) surface of the component and may also mean that another component may be interposed between the component and any arbitrary element disposed (or located or positioned) on (or under) the component.

In addition, it will be understood that when an element is referred to as being “coupled,” “linked” or “connected” to another element, the elements may be directly “coupled,” “linked” or “connected” to each other, or an intervening element may be present therebetween, through which the element may be “coupled,” “linked” or “connected” to another element. In addition, when a part is referred to as being “electrically coupled” to another part, the part can be directly connected to another part or an intervening part may be present therebetween such that the part and another part are indirectly connected to each other.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

In some embodiments of the cylindrical-type battery according to an embodiment of the present disclosure, one of the cylindrical-type batteries is selected, and the selected battery is described as having a general structure, and for commonly applied technologies, describe the general structure of cylindrical-type cells.

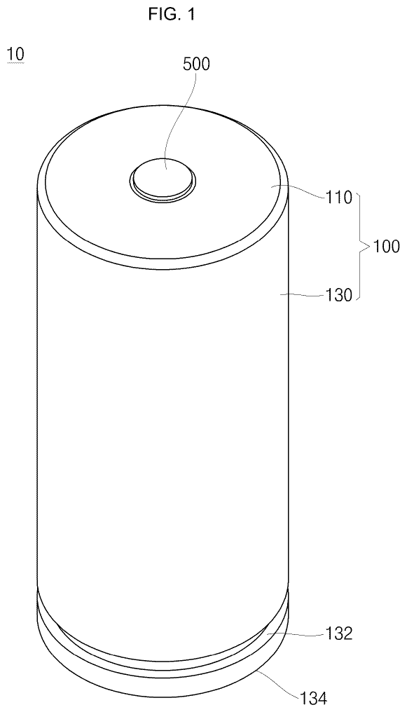

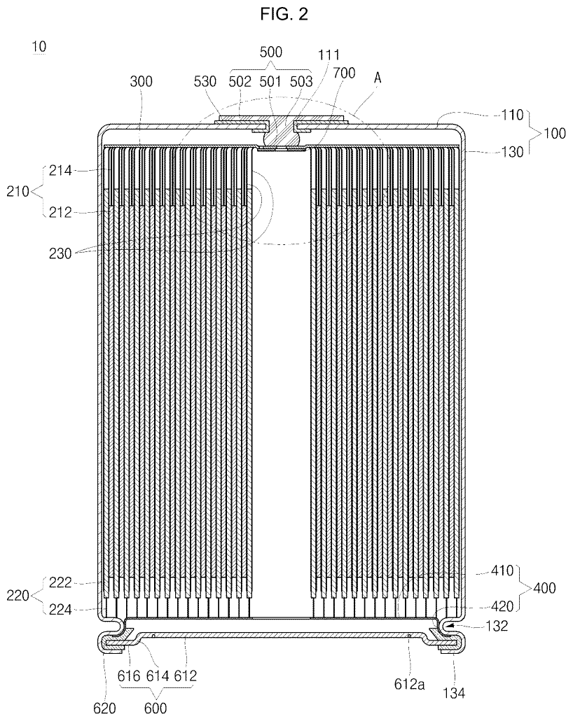

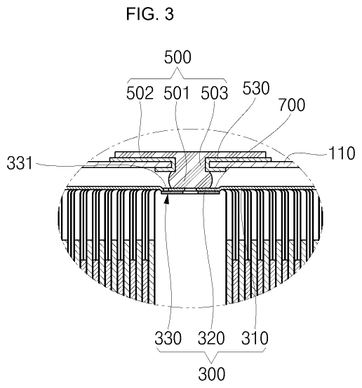

FIG. 1 is a perspective view of an exemplary secondary battery 10 according to a first embodiment of the present disclosure, FIG. 2 is a sectional view of the secondary battery 10 according to the first embodiment of the present disclosure, and FIG. 3 is an enlarged view of portion A in FIG. 2.

Referring to FIGS. 1 to 3, the secondary battery 10 includes an electrode assembly 200, a case 100 that accommodates the electrode assembly 200 and an electrolyte therein, a first current collector plate 300, a second current collector plate 400, a terminal 500 on one side of the case 100, and a cap plate 600 on the other side of the case 100.

Referring to FIGS. 1 and 2, the case 100 may include a circular upper side portion 110 and a cylindrical lateral side portion 130 extending downward from the upper side portion 110. In some embodiments, the lower portion of the lateral side portion 130 may be open, and the case 100 may have a cylindrical shape with an open lower end.

A terminal hole 111 may be formed through the center of the upper side portion 110 of the case 100, and the terminal 500 may be installed in the terminal hole 111.

The lateral side portion 130 may have an upper end connected to the upper side portion 110 such that the lateral side portion 130 and the upper side portion 110 are integral. The lower end of the lateral side portion 130 may be open, and the cap plate 600 may be coupled to the open end. A beading part 132 may be formed in the lateral side portion 130 adjacent to the lower end. The beading part 132 may extend concavely inward from the lateral side portion 130. The end spaced apart from the beading part 132 may be bent toward the inside of the case 100, forming a crimping part 134. Due to the beading part 132, separation of the electrode assembly 200 can be prevented (or at least mitigated). In some embodiments, the cap plate 600 may be between the beading part 132 and the crimping part 134. The crimping part 134 may be configured to secure the cap plate 600 and to seal the case 100.

The case 100 accommodates the electrode assembly 200 and an electrolyte, and, together with the cap plate 600, can form the external appearance of the secondary battery 10. The case 100 may be made of iron plated with nickel, for example.

The electrode assembly 200 may include a separator 230 and a first

electrode 210 and a second electrode 220 positioned with the separator 230 interposed therebetween and may be wound in a jelly-roll shape.

The first electrode plate 210 includes a first substrate and a first active material layer on the first substrate. A first uncoated portion of the first substrate where the first active material layer is not located may extend outwardly, and a plurality of first substrate tabs 214 may be formed by processing the first uncoated portion by notching, for example. In this embodiment, the first substrate tabs 214 may be located toward the upper side portion 110 of the case 100. The first electrode plate 210 may be electrically connected to the terminal 500 through the first current collector plate 300. The first current collector plate 300 and the first substrate tabs 214 may be electrically and mechanically coupled to each other by welding, and the terminal 500 may be electrically and mechanically coupled to the first current collector plate 300 by welding.

The second electrode plate 220 includes a second substrate and a second active material layer on the second substrate. A second uncoated portion of the second substrate where the second active material layer is not located may extend outwardly, and a plurality of second substrate tabs 224 may be formed by processing the second uncoated portion by notching, for example. In this embodiment, the second substrate tabs 224 may be located toward the lower portion of the case 100. The second electrode plate 220 may be electrically connected to the case 100 through the second current collector plate 400. The second current collector plate 400 and the second substrate tabs 224 may be electrically and mechanically coupled to each other by welding, and the second current collector plate 400 may be electrically and mechanically coupled to the case 100.

The first electrode plate 210 may act as a positive electrode. In such an embodiment, the first substrate may be made of, for example, an aluminum foil, and the first active material layer may include, for example, a transition metal oxide. The second electrode plate 220 may act as a negative electrode. In such an embodiment, the second substrate may be made of, for example, a copper foil or a nickel foil, and the second active material layer may include graphite, for example.

The separator 230 prevents a short circuit between the first electrode plate 210 and the second electrode plate 220 while allowing movement of lithium ions therebetween. The separator 230 may be made of, for example, a polyethylene film, a polypropylene film, a polyethylene-polypropylene film, or the like.

The first current collector plate 300 may have a disk shape and may be made of the same material as the first electrode plate 210. The first current collector plate 300 may be welded in a state in which the lower side thereof is in contact with the first substrate tabs 214. In addition, the upper side of the first current collector plate 300 may be welded to the rivet-shaped terminal 500. Accordingly, the first current collector plate 300 and the terminal 500 may be electrically connected, and as a result, the first electrode plate 210 and the terminal 500 may be electrically connected to each other by the first current collector plate 300.

The second current collector plate 400 may be made of the same material as the second electrode plate 220. The second current collector plate 400 may include a disk-shaped plate portion 410 and a contact portion 420 extending from the plate portion 410. The upper side of the plate portion 410 may be welded to and in contact with the second substrate tabs 224. Accordingly, the second current collector plate 400 and the second electrode plate 220 may be electrically connected to each other. The contact portion 420 may extend downward from the edge of the plate portion 410 and may be in close contact with the inner surface of the beading part 132. The contact portion 420 may be welded to the beading part 132 and electrically connected thereto.

The cap plate 600 may include a disk-shaped planar portion 612, an inclined surface 614 connected to the planar portion 612, and an extension surface 616 connected to the inclined surface 614. The planar portion 612 may be approximately parallel to the second current collector plate 400. The inclined surface 614 may be inclined downward from the edge of the planar portion 612. The extension surface 616 extends from the edge of the inclined surface 614 and may be parallel (or substantially parallel) to the planar portion 612. The extension surface 616 may be between the beading part 132 and the crimping part 134 and surrounded by the gasket 620. A notch 612a may be on the planar portion 612. The notch 612a may be configured to be broken in response to the pressure inside the secondary battery 10 being above a certain pressure. The internal gas of the secondary battery 10 may be discharged when the notch 612a is broken. That is, the notch 612a is configured to function as a vent.

The gasket 620 may insulate the case 100 and the cap plate 600 from each other. The gasket 620 is between the lower portion of the beading part 132 and the crimping part 134 and may cover the extension surface 616 of the cap plate 600. The gasket 620 may cover part or all of the extension surface 616. The side where the gasket 620 and the extension surface 616 are in contact with each other may be defined as the inside, and the side where the gasket 620 is in contact with the beading part 132 may be defined as the outside. In one or more embodiments, a portion of the contact portion 420 of the second current collector plate 400 may be between the outer upper portion of the gasket 620 and the beading part 132. Therefore, the contact portion 420 of the second current collector plate 400 and the extension surface 616 of the cap plate 610 are not in contact with each other due the gasket 620. That is, the gasket 620 may insulate the cap plate 600 and the case 100 from each other, and may insulate the cap plate 600 and the second current collector plate 400 from each other. The gasket 620 may be made of a resin material such as polyethylene (PE), polypropylene (PP), or polyethylene terephthalate (PET).

The terminal 500 may penetrate the upper side portion 110 of the case 100 and may be coupled to the case 100 through the gasket 530. The terminal hole 111 is at the center (or substantially the center) of the upper side portion 110 of the case 100, and the terminal 500 may be in the terminal hole 111. The terminal 500 may be installed by riveting. The terminal 500 may include a shank 501 extending through the terminal hole 111, a head 502 at one end of the shank 501 that is larger than the terminal hole 111 and supported on the outer surface of the case 100, and a fastening part 503 deformed to be larger than the terminal hole 111 at the other end of the shank 501 and supported on the inner surface of the case 100. The fastening part 503 may have a bucktail shape that is located inside the case 100. The fastening part 503 may be brought into contact with the first current collector plate 300 and welded, thereby achieving electrical and mechanical coupling between the terminal 500 and the first current collector plate 300. In an embodiment in which the first electrode plate 210 of the electrode assembly 200 is a positive electrode, the terminal 500 may function as a positive electrode terminal.

In some embodiments, the gasket 530 may be between the terminal 500 and the case 100 to form a seal and electrical insulation between the terminal 500 and case 100. The gasket 530 may be made of a resin material such as polyethylene (PE), polypropylene (PP), or polyethylene terephthalate (PET).

With the above-described structure, the terminal 500 has a positive polarity and the case 100 has a negative polarity.

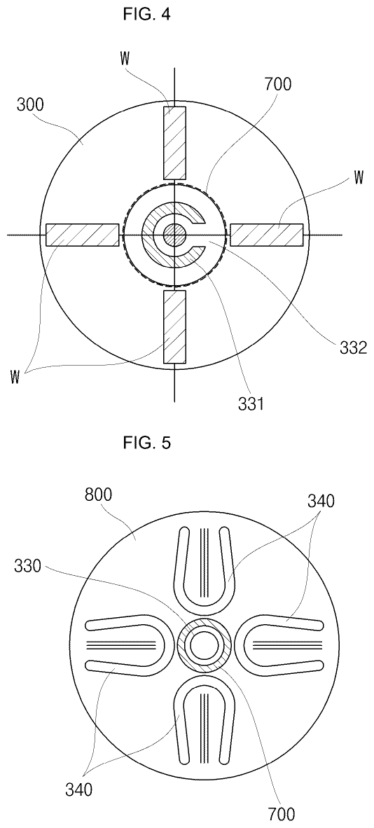

FIG. 4 is a diagram showing a first current collector plate, an insulating tape attached to the first current collector plate, and a welding area applied to the first current collector plate, according to an embodiment of the present disclosure.

Referring to FIGS. 3 and 4, the first current collector plate 300 may include an electrode plate connection part 310 connected to the first electrode plate 210, a terminal connection part 320 at the center (or substantially the center) of the electrode plate connection part 310 and in contact with the terminal 500, and a fuse part 330 between the electrode plate connection part 310 and the terminal connection part 320.

Referring to FIG. 3, the terminal connection part 320 protrudes toward the electrode assembly 200 and includes a step with respect to the electrode plate connection part 310. The first substrate tabs 214 of the first electrode plate 210 are coupled to the lower side of the electrode plate connection part 310, and the fastening part 503 of the terminal 500 may be coupled to the upper side of the terminal connection part 320.

The fuse part 330 may include a fuse hole 331 extending along a portion of the outer circumference of the terminal connection part 320, and an electrode plate joint part 332 that connects the terminal connection part 320 and the electrode plate connection part 310 to each other. The fuse hole 331 may extend along the outer circumference of the terminal connection part 320 in a circular shape in a plan view. Referring to FIG. 4, the fuse hole 331 may have a C-shape in plan view. Although FIG.

4 depicts an embodiment in which one fuse hole 331 is formed, a plurality of fuse holes may be formed, and the fuse holes may be located, for example, in a concentric circle relative to the center (or substantially the center) of the first current collector plate 300.

In some embodiments, an insulating member 700 may be on the first current collector plate 300. In FIG. 4, the insulating member 700 on the lower side of the first current collector plate 300 is shown as a dotted line. The insulating member 700 can be formed on the first current collector plate 300 by avoiding the welding area between the first current collector plate 300 and the first electrode plate 210, that is, the current collection welding area (W). In one or more embodiments, each of the current collection welding areas (W) may extend radially inward from the edge area of the first current collector plate 300, and the insulating member 700 may be formed in an area surrounded by a plurality of current collection welding areas (W).

Referring to FIG. 3, the insulating member 700 is on the lower side of the fuse part 330, and the diameter of the insulating member 700 may be equal to or larger than the diameter of the fuse part 330. The diameter of the insulating member 700 may be approximately 20% to approximately 40% of the diameter of the electrode assembly 200.

The insulating member 700 may be formed by attaching an insulating tape having an insulating property or by coating a material having an insulating property, such as polyimide (PI).

FIG. 5 is a diagram showing a first current collector plate and an insulating member on the first current collector plate, according to another embodiment of the present disclosure.

Referring to FIG. 5, the first current collector plate 800 may include a plurality of buffering slits 340 outside the fuse part 330. The plurality of buffering slits 340 may be arranged to be symmetrical (or substantially symmetrical) about the fuse part 330. The buffering slits 340 may have a U-shape in a plan view. The insulating member 700 may be on the lower side of the fuse part 330 and may avoid the current collection welding area and the buffering slits 340.

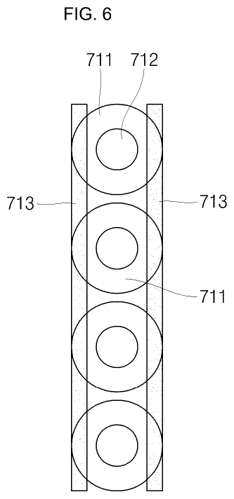

FIGS. 6 to 8 are diagrams showing an embodiment in which the insulating member 700 is formed by attaching an insulating tape with an adhesive.

Referring to FIG. 6, each of a plurality of insulating tapes 711 may be circular, and an adhesive 713 may be attached to portions of the insulating tapes 711 facing each other. In one or more embodiments, each insulating tape 711 has a through hole 712 at the center, and the adhesive 713 is not attached to the through hole 712.

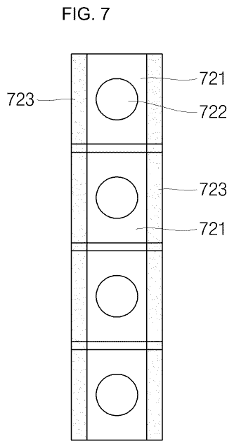

Referring to FIG. 7, each of a plurality of insulating tapes 721 may have a prismatic shape, and an adhesive 723 may be attached to portions of both edges of each of the insulating tapes 721 facing each other. In one or more embodiments, each of the insulating tapes 721 has a through hole 722 at the center, and the adhesive 723 is not attached to the through hole 722.

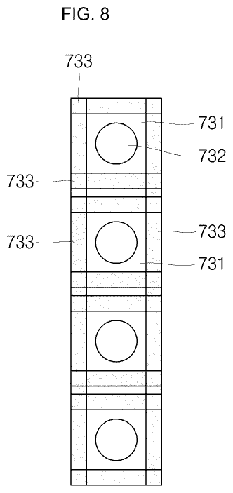

Referring to FIG. 8, each of a plurality of insulating tapes 731 may prismatic, and an adhesive 733 may be attached to both edges of each of the insulating tapes 731 facing each other. In one or more embodiments, each of the insulating tapes 731 has a through hole 732 at the center, and the adhesive 733 is not attached to the through hole 732.

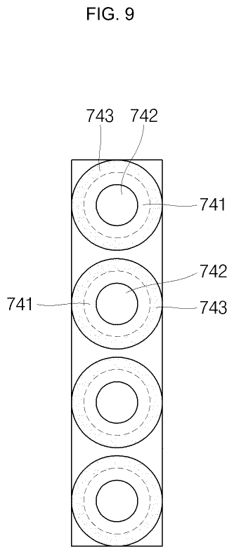

Referring to FIG. 9, each of a plurality of insulating tapes 741 may be circular, and an adhesive 743 may be attached along the edge of each of the insulating tapes 741. In some embodiments, the adhesive 743 may be attached to the outside of each of the insulating tapes 741 in a circular shape. In one or more embodiments, a through hole 742 is at the center of each of the insulating tapes 741, and the adhesive 743 is not attached to the through hole 742.

FIGS. 6 to 9 depict embodiments in which adhesives 713, 723, 733, and 743 are formed on several insulating tapes 711, 721, 731, and 741. After forming the adhesives 713, 723, 733, and 743, each of the insulating tapes 711, 721, 731, and 741 may be cut and used.

In some examples, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O₂₋ₐDa (0.90≤a≤1.8, 0≤b≤0.5, 0≤c≤0.5, 0<a<2); LiₐNi_{1-b-c}Mn_{b}X_{c}O₂₋ₐDa (0.90≤a≤1.8, 0≤b≤0.5, 0≤c≤0.5, 0<a<2); LiₐNi_{b}Co_{c}L¹_{d}GₑO2 (0.90≤a≤1.8, 0≤b≤0.9, 0≤c≤0.5, 0≤d≤0.5, 0e≤0.1); LiₐNiG_{b}O₂ (0.90≤a≤1.8, 0.001≤b≤0.1); LiₐCoG_{b}O2 (0.90≤a≤1.8, 0.001≤b≤0.1); LiₐMn₁₋₆G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li₍₃₋₁₎Fe₂(PO₄)₃(0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

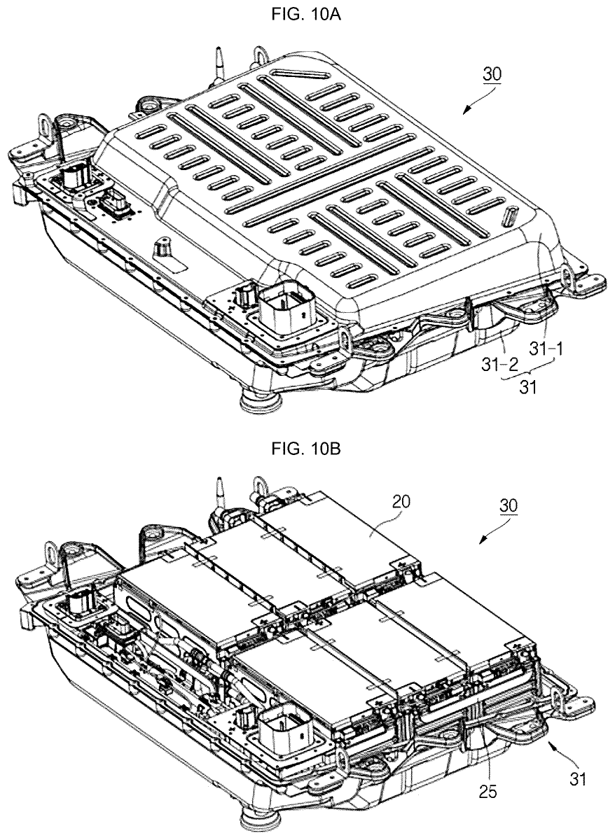

The secondary battery 10 according to the above-described embodiments may be used in manufacturing a secondary battery pack 30. FIGS. 10A and 10B are diagrams schematically showing the configuration of the secondary battery pack 30 according to an embodiment of the present disclosure.

Referring to FIGS. 10A and 10B, the secondary battery pack 30 may include a plurality of secondary battery modules 20 and a housing 31 for accommodating the plurality of secondary battery modules 20. In one or more embodiments, the housing 31 may include first and second housings 31-1 and 31-2, which are coupled in opposite directions (e.g., upper and lower directions) with the plurality of secondary battery modules 20 located therebetween. The plurality of secondary battery modules 20 may be electrically connected to each other using a bus bar 25, and the plurality of secondary battery modules 20 may be electrically connected to each other in a series/parallel or a series-parallel mixed manner, thereby obtaining a desired electric output. In the drawings, for brevity, components, such as bus bars for electrical connection of secondary cells (batteries), cooling units, and external terminals, are omitted.

The secondary battery pack 30 may be mounted on a vehicle 50. The vehicle 50 may be, for example, an electric vehicle, a hybrid vehicle, or a plug-in hybrid vehicle. Motor vehicles include four-wheeled vehicles or two-wheeled vehicles.

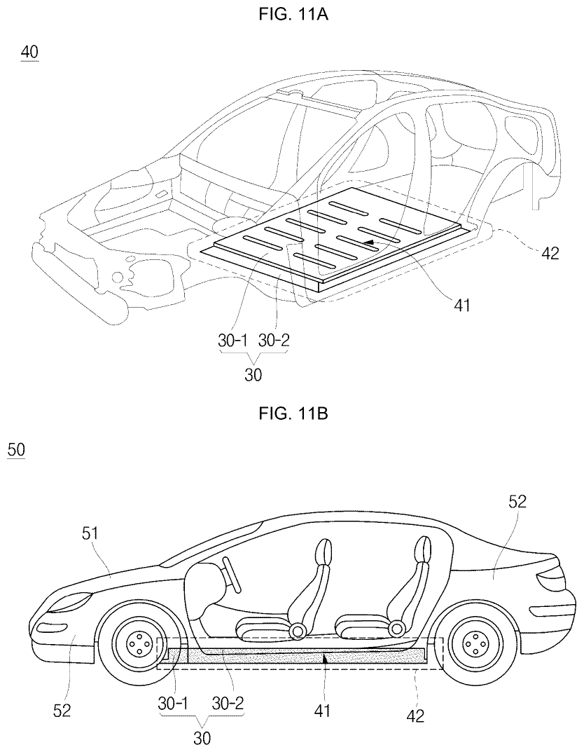

FIG. 11A is a perspective view showing a vehicle body 40. FIG. 11B is a diagram of a vehicle 50 including the secondary battery pack 30 of FIG. 10. In FIG. 11A, the secondary battery pack 30 may include a secondary battery pack cover 30-1, which is a part of the vehicle underbody 41, and a pack frame 30-2 disposed under the vehicle underbody 41. In some examples, the battery pack cover 30-1 may correspond to the first housing 31-1, and the pack frame 30-2 may correspond to the second housing 31-2. The secondary battery pack cover 30-1 and the pack frame 30-2 may be integrally formed with a vehicle floor 42. The vehicle underbody 41 separates the interior and exterior of the vehicle, and the pack frame 12 may be on the exterior of the vehicle.

Referring to FIG. 11B, the vehicle 50 may include additional parts, such as a hood 51 at the front of the vehicle and fenders 52 located at the front and rear of the vehicle, respectively, to the vehicle body 40. The vehicle 50 may include the secondary battery pack 30 including the secondary battery pack cover 30-1 and the pack frame 30-2, and the secondary battery pack 30 may be coupled to the vehicle body 40. The vehicle is configured to operate by receiving power from the secondary battery pack 30 according to an embodiment of the present disclosure.

According to the present disclosure, by attaching one or more insulating members to a current collector plate and avoiding a current collection welding area, stability within a cell can be increased and internal short circuits can be prevented (or at least mitigated).

However, the aspects and features of the present disclosure are not limited to those described above, and other aspects and features not expressly described herein will be clearly understood by a person skilled in the art from the description of example embodiments of the present disclosure described below.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly comprising a first electrode plate, a separator, and a second electrode plate;
a case accommodating the electrode assembly, the case comprising an open lower end;
a terminal extending through an upper side portion of the case and coupled to the case with a first gasket;
a first current collector plate between an upper side portion of the electrode assembly and the case, the first current collector plate electrically connecting the first electrode plate and the terminal to each other; and
a cap plate sealing the open lower end of the case,
wherein the first current collector plate comprises an electrode plate connection part connected to the first electrode plate of the electrode assembly, and a terminal connection part at a center of the electrode plate connection part and connected to the terminal,
wherein the terminal is coupled to a terminal hole of the case and comprises a fastening part inside the case, the fastening part being coupled to an upper side portion of the terminal connection part, and
wherein an insulating member is attached to the first current collector plate and avoids a current collection welding area between the first current collector plate and the first electrode plate.

2. The secondary battery as claimed in claim 1, wherein the first current collector plate further comprises a fuse part between the terminal connection part and the electrode plate connection part.

3. The secondary battery as claimed in claim 2, wherein the fuse part comprises:
a fuse hole along a portion of an outer circumference of the terminal connection part; and
an electrode plate joint part connecting the terminal connection part and the electrode plate connection part.

4. The secondary battery as claimed in claim 3, wherein the fuse hole has a C-shape in a plan view.

5. The secondary battery as claimed in claim 2, wherein the insulating member is attached to a lower side of the fuse part.

6. The secondary battery as claimed in claim 5, wherein a diameter of the insulating member is equal to or larger than a diameter of the fuse part.

7. The secondary battery as claimed in claim 5, wherein a diameter of the insulating member is approximately 20% to approximately 40% of a diameter of the electrode assembly.

8. The secondary battery as claimed in claim 1, wherein the insulating member is circular.

9. The secondary battery as claimed in claim 1, wherein the insulating member is prismatic.

10. The secondary battery as claimed in claim 1, wherein the insulating member comprises an insulating tape and an adhesive attached to both edges of the insulating tape facing each other.

11. The secondary battery as claimed in claim 1, wherein the insulating member comprises an insulating tape and an adhesive attached to a portion of an edge of the insulating tape.

12. The secondary battery as claimed in claim 1, wherein the insulating member comprises an insulating tape and an adhesive attached to an outside of the insulating tape along an edge of the insulating tape.

13. The secondary battery as claimed in claim 12, wherein the adhesive has a circular shape.

14. The secondary battery as claimed in claim 3, wherein the fuse hole has a circular shape in a plan view.

15. The secondary battery as claimed in claim 1, wherein the current collection welding area extends radially from an edge area of the first current collector plate.

16. The secondary battery as claimed in claim 2, wherein the first current collector plate is outside the fuse part and comprises a plurality of buffering slits arranged substantially symmetrically about the fuse part.

17. The secondary battery as claimed in claim 16, wherein each of the plurality of buffering slits is U-shaped in a plan view.

18. The secondary battery as claimed in claim 16, wherein the insulating member is attached to a lower side of the fuse part and avoids the current collection welding area and the plurality of buffering slits.

19. The secondary battery as claimed in claim 2, wherein the fuse part comprises one or more fuse holes, and wherein the one or more fuse holes are arranged in a concentric circle with respect to a center of the first current collector plate.

20. The secondary battery as claimed in claim 1, wherein the terminal connection part protrudes toward the electrode assembly and includes a step with respect to the electrode plate connection part.

21. The secondary battery as claimed in claim 1, wherein the insulating member comprises an insulating tape or a coating of a material having an insulating property.

22. The secondary battery as claimed in claim 1, wherein the case is cylindrical.
